(19) United States
(12) Patent Application Publication
(10) Pub. No.: US 2023/0196779 A1
(43) Pub. Date: Jun. 22, 2023

(54) OBSERVATION SYSTEM AND ASSOCIATED OBSERVATION METHOD

(71) Applicant: Commissariat à I'énergie atomique et aux énergies alternatives, Paris (FR)

(72) Inventors: Maxence Bouvier, Grenoble (FR); Alexandre Valentian, Grenoble (FR)

(73) Assignee: Commissariat à l'énergie atomique et aux énergies alternatives, Paris (FR)

(21) Appl. No.: 18/066,531

(22) Filed: Dec. 15, 2022

(30) Foreign Application Priority Data
Dec. 21, 2021 (FR) 21 14138

(51) Int. Cl. G06V 20/52; G06T 7/20; G06T 7/579; G06V 10/60; H04N 25/772

(52) U.S. Cl. CPC G06V 20/52; G06T 7/20; G06T 7/579; G06V 10/60; H04N 25/772; G06V 2201/07

(57) ABSTRACT

The present invention relates to an observation system (10) of an environment, the observation system (10) comprising:
a sensor (12) forming a synchronous stream of framed data,
a first processing chain (14) including:
a first reception unit (30) receiving the formed synchronous stream, and
a first processing unit (32) comprising a first conversion block (34) converting the synchronous stream into event data, and a first calculation block (36) calculating first data from the event data
a second processing chain (16) including a second processing unit (46) receiving a synchronous stream of framed data from the array (18) and the first data and obtaining second data relating to the environment as a function of the synchronous stream and the first data.

This patent application claims the benefit of document FR 21/14138 filed on Dec. 21, 2021, which is hereby incorporated by reference.

The present invention relates to an observation system and an associated method.

In the field of vision, it is common to distinguish conventional imagers from event-driven sensors.

Conventional imagers provide images, namely a succession of matrices which encode light intensity values measured by an array of pixels at a regular frequency.

The light intensity values are often values included between 0 and 255, even more with the most recent screens and most generally on 3 (or 4) channels, namely red, green, blue (and possibly “luminance”).

The conventional imagers present a relatively dense information, which makes it possible to obtain relatively precise information on the image scene such as object recognition information with an unequalled precision.

However, conventional imagers have several drawbacks.

These imagers are subject to motion blur. In fact, each pixel of a conventional camera temporally integrates the light flux it receives and when the imager moves, many light sources are integrated at the same pixel and the resulting image may appear blurred, especially when the motion is significant.

In addition, the range of light intensity values that can be measured by such an imager is often limited, unless you have expensive adaptive or inherently “wide range” systems. Indeed, the charge embedded in each pixel is usually converted to digital values with an analog-to-digital converter (also called ADC) shared by several pixels. Therefore, in the presence of a large variation of light in a group of pixels (the case of an object reflecting the sun), saturation phenomena can appear. In addition, the imagers capable of operating with a high dynamic range generally have a conversion time longer than those of lower dynamic range, a higher space requirement, and a higher cost.

In addition, the data from a conventional imager is relatively significant and generates a high load. Therefore, for an embedded system, a high latency can appear due to the time needed to perform the calculation. This can be problematic in situations requiring a quick understanding of the scene such as a pedestrian appearing in front of a vehicle.

Finally, it can be noted that the above-mentioned computational load is sometimes useless because of the high redundancy of the data from a conventional imager. In fact, even if all the objects in a scene are totally motionless, the conventional imager continues to acquire images at the same rate as if the objects were moving.

The second way corresponds to the domain of event-driven sensors.

A DVS sensor or an ATIS sensor are two examples of such a sensor. The abbreviation DVS stands for “Dynamic Vision Sensor”, while the acronym ATIS stands for “Asynchronous Time-based Image Sensor”.

An event-based sensor generates an asynchronous and sparse event stream since a pixel generates an event only when a temporal intensity gradient on the pixel exceeds a certain threshold.

An event-driven sensor therefore allows no data to be emitted when nothing is moving in front of the event-driven sensor, which greatly limits the amount of data to be processed.

An event-driven sensor can operate under very different light conditions (in particular, day and night) and presents a good motion detection capability with a relatively small amplitude, according to the settings (threshold value).

Moreover, because of the asynchronous operation, such sensors allow to detect without delay fleeting or very fast events, which would be invisible for a conventional image sensor. They thus allow to consider motion detection with very low latency. They also present the characteristic of performing an intrinsic contour extraction of moving objects, including visually ill-defined objects (light on light, or dark on dark), allowing to reinforce the detection and classification algorithms used with conventional imagers.

On the other hand, this asynchronous behavior, strongly linked to the movements in front of the sensor, presents some disadvantages. The first is the very large number of events generated when the whole scene is moving (for example when the sensor itself is moving). For some sensors, the rate of generated events can be as high as 10 GeV/s (GeV/s stands for “Giga Events per second” and represents the number of billions of events per second contained in an event stream). Such a frequency of acquisition implies in return an important computing power if one wants to make complex processes in order to be able to process the events of the event stream.

The second drawback is that the number of events generated per second is not predictable. The computational load is not predictable either, so that it is difficult to process the data with maximum efficiency (which is often obtained when the processing is implemented with maximum load).

In addition, due to the intrinsic noise of asynchronous pixels, an event-driven sensor generates spurious events, which further increases the computational load unnecessarily.

Therefore, there is a need for an observation system that can benefit from the advantages of both types of imagers mentioned above, while remaining compatible with a physical implementation in an embedded system.

To this end, the description describes an observation system for observing an environment, the observation system comprising a sensor including an array of pixels, each pixel being a sensor able to acquire the intensity of the incident light during an observation of the environment, and a readout unit, the readout unit being able to read the intensity values of the pixels to form a synchronous stream of framed data, the observation system also comprising a first processing chain including a first reception unit able to receive the synchronous stream from the sensor and a first processing unit comprising a first conversion block able to convert the synchronous stream received by the first reception unit into event data, and a first calculation block able to calculate the first data from the event data, the observation system also comprising a second processing chain distinct from the first processing chain and including a second processing unit able to receive a synchronous stream of framed data coming from the array of pixels and the first data and to obtain second data relating to the environment as a function of the synchronous stream and the first data.

In the context of the present invention, one aim, in particular, is to perform non-complex processing to limit the computing power required on the events of the event stream. Nevertheless, the invention makes it possible to obtain the results of complex processing while benefiting from the advantages of each of the imaging channels. The event-based imager allows to detect a movement very quickly, to react with a low latency (what can be called the “where” channel); the conventional imager, with its richness in terms of color and texture, allows to classify more easily (what can be called the “what” channel).

According to particular embodiments, the observation system presents one or more of the following features, taken alone or in any technically possible combination:
the readout unit presents a first acquisition frequency for the first processing chain and a second acquisition frequency for the second processing chain, the ratio between the first acquisition frequency and the second acquisition frequency being strictly greater than 1, preferably strictly greater than 10.
the first processing unit is able to transmit the first data at a first transmission frequency, the second processing unit is able to transmit the second data at a second transmission frequency, the ratio between the first transmission frequency and the second transmission frequency being strictly greater than 1, preferably strictly greater than 10
the readout unit presents an adjustable acquisition frequency.
the readout unit presents analog-to-digital converters with adjustable precision.
the first data are data relating to the temporal evolution of an object in the scene.
the first processing unit includes a compensation subunit, the compensation subunit being able to receive data relating to the movement of the sensor and able to apply a compensation technique to the event data converted by the first conversion block as a function of the received data in order to obtain a compensated event stream, the first processing unit also including a frame reconstruction subunit, the reconstruction subunit being able to generate corrected frames from the compensated event stream, the first data including the corrected frames.
the first processing unit further includes an obtaining subunit, the obtaining subunit being able to obtain at least one characteristic relating to the nature of the movement of an object in the scene, the first data including the at least one characteristic obtained.
the second data are recognition or identification data of an object in the scene.
the second processing unit is able to apply an evaluation technique to the first and second data to obtain evaluated positions of the sensor.
the evaluation technique is a visual odometry technique or a simultaneous location and mapping technique.
the second processing unit is able to perform preprocessing on the synchronous stream.
the first calculation block performs preprocessing on the synchronous stream to obtain a corrected synchronous stream, the preprocessing being able to use first data in particular, the second processing unit being able to receive the corrected synchronous stream,
the first processing unit includes a set of cores, each core being associated with a respective set of pixels and applying identical processing to said set of pixels,
the sensor, the first processing unit and the second processing unit are part of the same component including a stack of at least three layers, the first layer of the stack including the sensor, the second layer of the stack including the first processing unit and the third layer including the second processing unit, the second layer being connected to the first layer and to the third layer by respective three-dimensional links.

The description also describes an observation method for observing an environment, the observation method being implemented by an observation system, the observation system comprising a sensor comprising an array of pixels and a readout unit, a first processing chain including a first reception unit and a first processing unit comprising a first conversion block and a first calculation block, and a second processing chain distinct from the first processing chain and including a second processing unit, the observation method comprising the steps of acquiring by each pixel the intensity of the incident light on the pixel during an observation of the environment, reading of the intensity values of the pixels by the readout unit to form a synchronous stream of framed data, receiving the synchronous stream from the sensor by the first reception unit, converting the synchronous stream received by the first conversion block into event data, calculating the first data from the event data by the first calculation block, receiving the synchronous stream from the sensor and the first data by the second processing unit, and obtaining the second data relating to the environment as a function of the data received by the second processing unit.

Features and advantages of the invention will become apparent from the following description, given only as a non-limiting example, and made with reference to the attached drawings, in which:

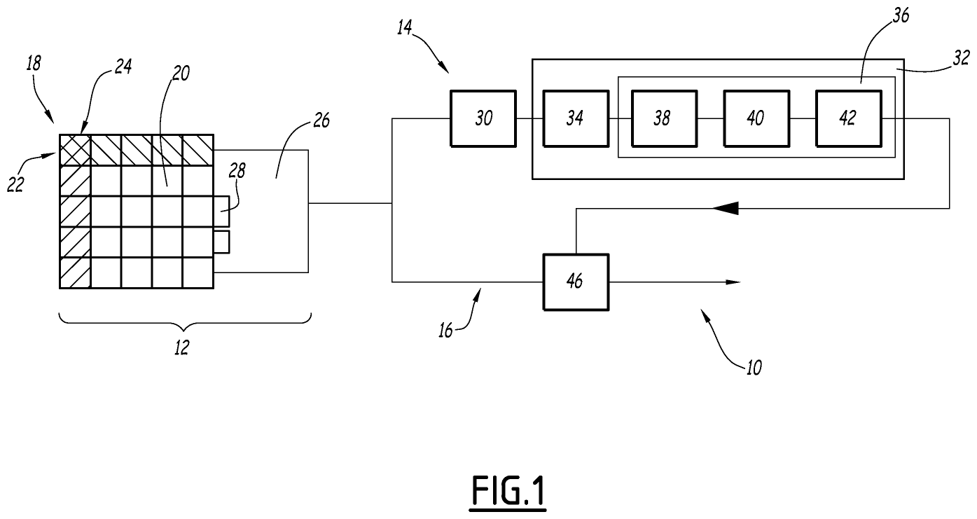

FIG. 1 is a schematic representation of one example of the observation system including processing chains,

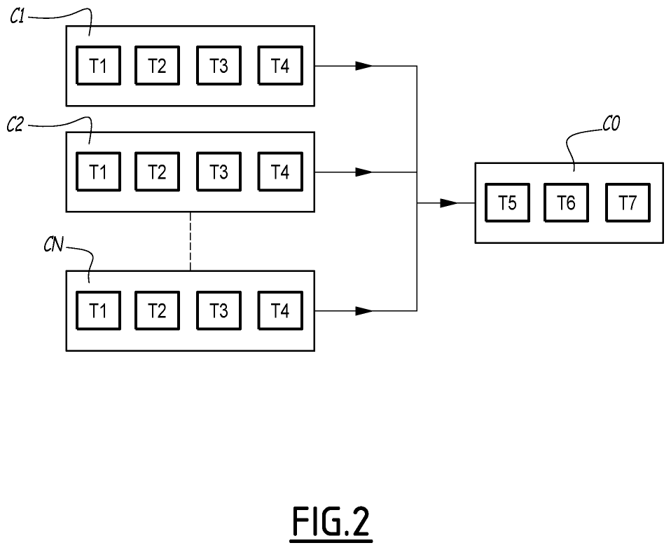

FIG. 2 is a schematic representation of one example of the processing chain, and

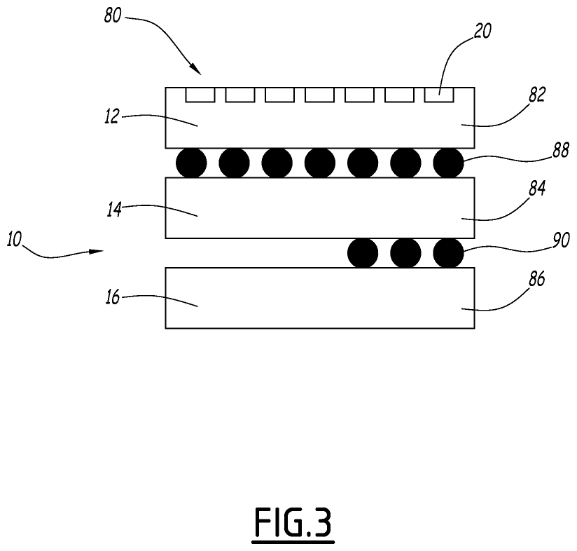

FIG. 3 is a schematic representation of one example of the physical implementation of an observation system of FIG. 1.

An observation system 10 is shown in FIG. 1.

The representation is schematic in that it is an operational type of block representation that provides a clear understanding of the operation of the observation system 10.

The observation system 10 is able to observe a scene corresponding to an environment.

The observation system 10 includes a sensor 12, a first processing chain 14 and a second processing chain 16.

It can be stressed here that these three elements are distinct so that the observation system 10 includes 3 blocks, each with a specific role.

In a very schematic way, the sensor 12 is used to acquire images, the first processing unit 14 is used to perform processing on event type data and the second processing unit 16 is used to perform processing on data corresponding to conventional images.

Furthermore, the second processing chain 16 is distinct from the first processing chain 14.

The second processing chain 16 performs processing in parallel with the first processing chain 14.

The two processing chains 14 and 16 thus simultaneously perform processing on data from the sensor 12.

The roles of each of the blocks are described in more detail in the following.

The observation system 10 is able to interact with a measurement unit, for example integrated into the observation system 10.

The measurement unit is a motion measurement unit.

The measurement unit is able to measure the movement of the sensor 12.

According to the proposed example, the measurement unit is an inertial measurement unit.

Such an inertial measurement unit is sometimes referred to as an inertial measurement unit, or more often as an IMU, which refers to the English term “Inertial Measurement Unit”.

The measurement unit thus includes gyros and accelerometers for measuring the rotational and translational movements of the sensor 12. The measurement unit may also include magnetometers.

According to the case, the output data from the motion measurement unit may be raw or integrated data.

For example, the integrated data is expressed as a rotation matrix R corresponding to rotational movements of the sensor 12 or a translation matrix T corresponding to translational movements of the sensor 12.

Alternatively, the rotation data is provided using a quaternion which is typically a vector with four values, with one value representing the norm, the other values being normed and characterizing the rotation in space.

The sensor 12 comprises an array 18 of pixels 20.

The array 18 is thus a set of pixels 20 arranged in rows 22 and columns 24.

The pixels 20 are pixels of a conventional imager and not of an event-driven sensor.

The pixels 20 are therefore each a sensor temporally integrating the received light and delivering a signal proportional to the result of the temporal integration of the incident light on the sensor of the pixel 20.

According to the example of FIG. 1, the pixels 20 are CMOS type pixels, the abbreviation CMOS referring to the English name of “Complementary Metal Oxide Semiconductor” literally meaning complementary metal-oxide-semiconductors.

In addition, the array 18 can be a colored matrix, in particular an RGB type matrix. In such a matrix, some pixels 20 give the light intensity of the red color, others of the blue color and still others of the green color. For this, it is possible to use a Bayer filter.

According to an example, the readout unit 26 of the pixels 20 is able to read the intensity values of each of the pixels 20.

For this purpose, by way of illustration, the readout unit 26 uses analog-to-digital converters generally shared for a set of pixels in the same column. Alternatively, a digital-to-analog converter may be provided in each pixel, although this is less common given the space requirements of each pixel.

The readout unit 26 is able to produce a frame of data corresponding to an image, this image consisting of the values read for all the pixels of the matrix.

The transformation into a frame is carried out at a constant acquisition frequency. Generally, the pixels are read line by line, the pixels of the same line being read in parallel by reading blocks placed at the foot of the columns.

The readout unit 26 thus operates synchronously since the readout unit 26 is capable of generating a synchronous stream of framed data, a frame being emitted by the readout unit at said frame rate.

According to the example in FIG. 1, 4 neighboring pixels 20 are grouped to form a set sharing the same analog-to-digital converter. The set of 4 pixels 20 is generally called a macropixel.

When the readout unit 26 comes to read the pixel values, it preferably performs this reading in “global shutter” mode, (literally meaning global obturation) namely, the set of pixels presents an identical temporal integration window and the output of each analog-to-digital converter allows to indicate a value for each pixel of a macropixel corresponding to a “same instant” of reading, even if the readings or, in other words, the readings of the values present in the pixels which are carried out by means of a shared analogue converter can be carried out sequentially as a frame corresponding to the construction of an image.

Of course, the value of 4 pixels 20 is not limiting and it is possible to consider macropixels with a different number of pixels 20. Furthermore, as is known per se, it is possible for the imager to have different resolution modes, where the pixels can, for example, all be read independently at high resolution, or averaged within a macropixel to output a single value for a macropixel at a lower resolution.

In a variant where some pixels 20 are colored pixels, working with macropixels allows, in particular, to realize the equivalent of a pixel with 4 pixels, or “sub-pixels” presenting different colored filters. Thus, the macropixel of 4 different colored pixels makes it easier to convert a colored pixel into a gray level to facilitate the reception of data by the first processing chain 14. This effect is achieved due to the physical proximity of a pixel to its neighbors, which makes the information more easily accessible.

In the example described the readout unit 26 has an adjustable acquisition frequency, in particular between 5 Hertz (Hz) and 100 kilohertz (kHz).

It may be indicated here that, according to the selected acquisition frequency, the integration time per pixel may possibly, but not necessarily, vary, for example to adapt the dynamics of the intensity value ranges that can be measured by the sensor 12. The precision of the analog-to-digital converter may be modulated to allow the acquisition frequency to be modified, as a high frequency may require the precision of the converter to be reduced.

Preferably, to ensure rapid operation of the first processing chain 14, the acquisition frequency is greater than or equal to 10 kHz.

In addition, according to one embodiment, the accuracy of each analog-to-digital converter is adjustable.

Thus, when a frame is destined for the second processing chain 16, the precision would be maximum, whereas when a frame is destined for the first processing unit 14, a lower precision might be sufficient. Changing the accuracy may allow the acquisition frequency for the first processing chain 14 to be increased and therefore maintain the high dynamic range properties of the first processing chain 14.

In such a case, the readout unit 26 presents two different acquisition frequencies, a first acquisition frequency f_{ACQ 1} for the first processing chain 14 and a second acquisition frequency f_{ACQ 2} for the second processing chain 16. The first acquisition frequency f_{ACQ 1} is greater than the second acquisition frequency f_{ACQ 2}, preferably greater than 10 times the second acquisition frequency f_{ACQ 2}.

The first acquisition frequency f_{ACQ 1} is, for example, greater than 100 Hz while the second acquisition frequency f_{ACQ 2} is less than 10 Hz.

The first processing chain 14 is positioned at the output of the sensor 12.

The first reception unit 30 is thus able to receive the synchronous stream of framed data from the array 18 of pixels 20.

The first processing chain 14 is able to process the synchronous stream of framed data to obtain first data.

As will be detailed in what follows, the first data is data relating to the temporal evolution of at least one object in the scene imaged by the sensor 12.

From a functional point of view, the first processing chain 14 includes a first reception unit 30 and a first processing unit 32.

The first processing unit 32 includes a first conversion block 34 and a first calculation block 36.

The first conversion block 34 is able to convert the synchronous stream of framed data from the sensor 12 into an event stream.

In other words, the first conversion block 34 is able to convert a conventional image stream acquired at relatively high speed, namely, a set of frames over a time interval, into event-driven data over the same time interval. Such a time interval can be called an observation time interval.

The observation time is much greater than the first acquisition time, the first acquisition time being the inverse of the first acquisition frequency f_{ACQ 1} As a result, several frames are transmitted by the readout unit 26 during this observation time.

Furthermore, it may be noted that the observation time is quite different from the integration time of the sensor 12.

According to a simple embodiment, the conversion by the first conversion block 34 is implemented as follows.

An array of intensity data is received. The array of intensity data corresponds to a measurement at an instant t.

The first conversion block 34 then calculates, for each pixel 20, the relative difference between the light intensity value I_{curr} of the received array of intensity data and the light intensity value Iₚᵣₑᵥ of a previous array corresponding to a measurement at the immediately preceding instant. The light intensity value of each pixel of the prior frame is stored in a memory of a first processing unit 32.

The first conversion block 34 compares the difference value to a contrast threshold Cₜₕ.

When the difference value is greater than the contrast threshold Cₜₕ, an event is generated. The event is generated in the form of a pulse for the pixel considered. Such a pulse is often referred to as a “spike” in reference to the corresponding English terminology.

In addition, the light intensity value stored in the memory for the pixel at the origin of the spike is updated with the light intensity value I_{curr} of the received intensity framed data.

When the difference value is less than the contrast threshold Cₜₕ, no event is generated for that pixel and the light intensity value stored in the memory is not changed for that pixel.

The generation of a spike for a pixel 20 by the first conversion block 34 therefore only takes place if the condition on the difference between the two light intensity values is met.

It should be noted that the method described above performs a form of integration of the intensity differences between two successive instants. It is only when the sum of these differences exceeds a threshold that an event is generated, followed by a reinitialization of the integration operation. Other methods of integrating the intensity of a pixel with a reinitialization when an event is generated can be implemented by the conversion unit 34. The above example with a memory size equivalent to the pixel array is a particularly compact and efficient implementation.

Alternatively, other conditions may be used.

For example, the condition is as follows:

$$\frac{{I}_{curr} - {I}_{p r e v}}{{I}_{p r e ν}} \geq {C}_{th}$$

According to another variant, the condition uses a logarithm as follows:

$$log ( \frac{{I}_{c u r r} - {I}_{p r e ν}}{{I}_{p r e ν}} ) \geq {C}_{th}$$

Nevertheless, in each case, the spike generation only occurs if the condition (or conditions in some cases) is met to ensure high rate operation of the first processing unit 32.

Because event generation takes place in the first conversion block 34, the event data can be considered emulated event data in the sense that it is not data from an event sensor. This is data from a conventional imager transformed into event data as if the data came from an event sensor.

The first conversion block 34 is then able to transmit the event data thus generated to the first calculation block 36.

The format in which the event data is transmitted by the first conversion block 34 varies according to the different embodiments without affecting the operation of the first calculation block 36.

According to a first example, a pulse is often expressed according to the AER protocol. The acronym AER refers to the English name of “Address Event Representation” which literally means representation of the event address.

With such a formalism, a spike is represented in the form of a plurality of information fields.

The first information field is the address of the pixel 20 that generated the spike. The address of the pixel 20 is, for example, encoded by giving the row number 22 and the column number 24 of the array 18 of pixels where the pixel 20 under consideration is located.

Alternatively, an encoding of the type y*xₘₐₓ+x or x*yₘₐₓ+y can be used. In the preceding formula, x designates the number of the column 24 of the pixel 20, y the number of the line 22 of the pixel 20, xₘₐₓ the number of columns 24 and yₘₐₓ the number of lines 22 of the array 18 of the pixels 20.

The second information field is the instant of the spike generation by the pixel 20 that generated the spike.

This implies that the first conversion block 34 is able to timestamp the spike generation with good accuracy to facilitate the application of the operations of the first operation block to the generated event stream.

The third information field is a value relative to the spike.

In the following, as an example, the third information field is the polarity of the spike.

The polarity of a spike is defined as the sign of the intensity gradient measured by the pixel 20 at the instant of spike generation.

According to other embodiments, the third information field is the light intensity value at the spike generation instant, or even the precise value of the measured intensity gradient.

Alternatively, the plurality of information fields includes only the first information field and the second information field.

According to another embodiment, the asynchronous event stream is represented not as a stream of spikes giving a positioning identifier of each spike but as a succession of hollow matrices, that is, mostly empty matrices.

As a particular example, the matrix is a matrix where each element has three possible values: a null value if no spike is present, a value equal to +1 or −1 if a spike is present, the sign depending on the polarity of the spike, namely, the intensity gradient.

The matrix can be transmitted with a timestamp that corresponds to the instant of emission of this matrix.

The matrix could also encode the precise value of the “reading” instant corresponding to the moment when the intensity value of at least one pixel that led to the emission of the pulse or “spike” was measured (in order to keep more precise information than the simple instant of emission of the matrix). It should be noted that, due to the synchronous processing of the conversion unit 34, the few pixels likely to deliver an event at the same instant all have the same reading instant.

The first calculation block 36 is able to calculate the first data from the event stream transmitted by the first conversion block 34.

To do this, the first calculation block 36 applies one or more operations on the event data.

The operations may vary widely according to the desired first data for the intended application.

According to the example described in FIG. 1, one processing operation performed by the first calculation block 36 is to obtain information about a region of interest (more often referred to as ROI) from information about the motion itself of the sensor 12 during the observation period, to obtain motion-compensated, or modified, data.

The compensated data is EMC type data. The acronym EMC refers to the English name of “Ego-Motion Compensation” or “Ego-Motion Correction”, which literally means compensation of its own motion or correction of its own motion.

In such a hypothesis, the first calculation block 36 thus includes a compensation subunit 38.

In addition, the pixel coordinates 20 should be calibrated. Such a calibration does not correspond to the self-motion compensation just described but serves to correct the geometric distortions induced by the optical system.

Therefore, a representation of the event data according to the AER protocol is preferable. This simplifies the calibration of all the events because this operation can be performed in the stream itself.

However, it would also be possible to consider performing the calibration by a readdressing mechanism using a lookup table (more often referred to as LUT).

The compensation subunit 38 thus takes as input the generated event stream, each event of which is a spike characterized by the three information fields.

The compensation subunit 38 is also suitable for receiving measurements of the movement of the sensor 12 during the observation time interval.

More specifically, the compensation subunit 38 receives motion related data from the motion measurement unit.

The compensation subunit 38 is also able to apply a compensation technique to the generated event stream based on the received motion data to obtain a compensated event stream within the observation time interval.

According to the example in FIG. 1, the compensation technique includes a distortion cancellation operation introduced by the optical system upstream of the array 18 of pixels 20 followed by a compensation operation for the motion of the sensor 12.

During the cancellation operation, the first information field relating to the position of a pixel is modified by taking into account the distortion.

It should be noted that the cancellation operation can be replaced or completed by an operation of partial compensation of the optical aberrations introduced by the optical system.

The compensation operation corrects the position of the spikes corrected by the cancellation operation as a function of the movements of the sensor 12.

For example, the compensation operation for the movements of the sensor 12 includes the implementation of two successive suboperations for each pulse.

During the first suboperation, the value of the rotation matrix R and the translation matrix T at the instant of generation of the spike are determined. Such a determination is, for example, implemented by an interpolation, in particular between the rotation matrices R and the known translation matrices T closest to the instant of generation of the spike.

The second suboperation then consists of multiplying the coordinates obtained at the output of the first operation with the rotation matrix R and then adding the translation matrix T to obtain the coordinates of the spike after taking into account the own motion of the sensor 12.

The first calculation block 36 also includes an event frame reconstruction subunit 40.

The reconstruction subunit 40 is able to generate corrected event frames from the compensated event stream in the observation time interval.

Such a reconstruction subunit 40 may be referred to as an EFG subunit, where EFG refers to the English name for “Event-Frame Generation” which literally means event frame generation.

The reconstruction subunit 40 takes the compensated event stream from the compensation subunit 38 as input and produces reconstructed event frames as output.

In the reconstructed frames, objects that are motionless in the scene observed by the observation system 10 ideally appear perfectly—clear and sharp. Conversely, objects that are moving in the observed scene appear blurred.

The apparent intensity of the blurring of an object depends on several factors.

A first factor is the speed of the object projected onto the sensor 12. This first factor depends on both the direction of the movement of the object as well as its own speed.

A second factor is the observation time of an event frame. Such a parameter of the reconstruction subunit 40 can be varied if necessary to show more or less apparent blur and thus objects in relative motion with respect to the fixed world.

Because the observation time is adjustable, several projected speeds can be corrected. The term “projected speed” should be understood here to mean the speed in the reference frame of the sensor 12 or the relative speed relative to the sensor 12. Once the compensation subunit 38 has performed the compensation technique, the frame observation time parameter can be changed without having to repeat the application of the compensation technique since the two subunits (compensation and reconstruction) are independent.

In addition, reconstructing an event frame in an interval can be achieved by reconstructing intermediate frames. As an example, the reconstruction of a frame with an observation time corresponding to an interval between 0 and 20 milliseconds (ms) can be obtained by reconstructing 4 frames of respectively 5 ms, 10 ms, 15 ms and 20 ms without starting from 0 each time (namely, performing 4 reconstructions at the 4 previous values).

For each observation time, objects moving with a projected speed in a corresponding interval will be sharp while objects moving at a lower or higher speed will appear blurred. For the case of the lowest duration (5 ms in the example), it is the objects that are moving relatively slowly with respect to the sensor 12 that are sharp while the objects that are moving quickly already appear blurred.

Thus, with such a technique, it is possible to detect and accentuate the blur for objects in the same scene moving at different speeds, and thus to detect many objects and obtain an indication of their speed.

The first calculation block 36 then includes an obtaining subunit 42.

The obtaining subunit 42 is suitable for determining one or more features in each reconstructed event frame.

For example, the obtaining subunit 42 is able to determine, for each event in the compensated event stream, the moving or motionless nature of an object associated with the event.

It is understood by the term “object associated with the event” that the object is the object in the environment that caused the first conversion block 34 to emulate the event.

The edges of a motionless object appear with better contrast than those of a moving object since the motion blur depends on the relative amount of motion/movement during the observation time.

Thus, for example, the obtaining subunit 42 searches for the contrast value of the edges of each object, compares that value to a threshold, and considers the object to be motionless only when the contrast value is greater than or equal to the threshold.

According to another embodiment or in combination, the obtaining subunit 42 uses the third information field.

Alternatively, the obtaining subunit 42 may extract the spatial boundaries of a region of interest corresponding to all possible positions of an object imaged by the observation system 10. As a particular example, the obtaining subunit 42 could then provide the coordinates of four points forming a rectangle corresponding to the region of interest.

More elaborately, the obtaining subunit 42 is able to determine other characteristics of the nature of the movement of the object.

In particular, the obtaining subunit 42 may determine whether the nature of the movement is primarily rotational.

As an example, the first data is then the output data of the obtaining subunit 42.

Other processing is possible for the first processing unit 32.

According to another embodiment, the first processing unit 32 implements an automatic learning algorithm.

Such an algorithm is more often referred to as “machine learning” due to the corresponding English terminology.

For example, the algorithm is implemented using a spike neural network.

A variant of the one described above in connection with FIG. 1 is described with reference to FIG. 2. According to this variant, the first processing chain 14 can be a central core C0 and a set of processing cores C1 to CN, N being the number of macropixels.

Each processing core C1 to CN is then associated with a respective macropixel, namely, that each core takes as input the output of an analog-to-digital converter of a macropixel.

Furthermore, the processing cores C1 to CN are spatially distributed to be in close proximity to their respective macropixel to allow direct access to the macropixels. The C1 to CN processing cores thus have a matrix spatial arrangement.

A C1 to CN processing core can then be interpreted as a processing subchain of a macropixel.

It is then possible to consider a functional architecture of the SIMD type. The abbreviation “SIMD” refers to the corresponding English term “Single Instruction on Multiple Data”, which literally translates as “one instruction, multiple data”.

In this case, this means that each processing core C1 to CN performs the same tasks.

According to the example in FIG. 2, each processing core C1 to CN performs four tasks T1 to T4.

The first task T1 is to obtain a set of values from the macropixel data. This corresponds to the task performed by the first reception unit 30.

The second task T2 is to convert the set of received values into spikes, which corresponds to the task performed by the first conversion unit 34.

The third task T3 is to perform the processing on the generated spikes. This corresponds to the task performed by the first calculation block 36.

The fourth task T4 is to send the processed value to the central core.

The central core C0 then implements three tasks T5 to T7.

The fifth task T5 is to collect all the values calculated by each core, the sixth task T6 is to combine all the collected values and the seventh task T7 is to send each combined value (corresponding to the first data) to the second processing chain 16 according to the example of FIG. 1.

Since each processing core C1 to CN can operate in parallel, this results in accelerated processing for the first processing chain 14.

In each of the above embodiments, the first processing chain 14 sends the first calculated data to the second processing chain 16.

Because of the variety of possible processing, the first data is very different according to the embodiments considered. Some examples are given in the following.

According to one example, the first data is data relating to the presence of objects in an area of interest.

According to yet another particular example, the first data is data evaluating motion blur on frames of events with compensated motion.

The first data may also characterize the motionless or moving nature of an object in the scene.

Alternatively, data involving processing subsequent to determining the moving or motionless nature may be of interest.

For example, the first data are all positions occupied by an object moving in space. This provides a region of interest in which the object is located during the observation interval.

It can also be considered to characterize the nature of the motion, for example if it is a rotational or translational motion.

For a motionless object, the first data will characterize its contour, for example, a characteristic of an edge of the object can then be a first data. It can be envisaged that the first data is the position of this edge or the dimension of the edge.

The aforementioned examples thus correspond to the nature of the movement of an object, to data relating to the extraction of a contour or to the presence or absence of an object.

The first calculation block 36 is able to transmit the first data at a first transmission frequency f_{émission 1}.

It can thus be understood here that the first calculation block 36 presents an output operation that can be described as synchronous in the sense that the transmission of the first data is synchronous with a clock having the transmission frequency f_{émission 1}.

The first transmission frequency f_{émission 1} is adapted to the type of data provided by the first processing chain 14. The first frequency can be relatively fast, typically between 100 Hz and 1 megahertz (MHz).

Such a speed results at least from a relatively fast execution frequency of the processing of the first processing chain 14.

The second processing chain 16 is able to process received data including the synchronous stream of conventional frames from the array 18 of pixels 20 and the first data to obtain the second data.

The second data are recognition or identification data of an object of the scene observed by the observation system 10.

The second processing chain 16 includes a second processing unit 46 receiving the aforementioned data, namely the synchronous stream of images from the array 18 of pixels 20 and the first data.

The second processing unit 46 is also able to obtain second data relating to the synchronous stream based on the data it has received.

To do this, the second processing unit 46 implements one or more operations on the received data.

According to the described example, the second processing unit 46 implements a technique for evaluating the position of the sensor 12.

By way of illustration, the evaluation technique implemented by the second processing unit 46 is a simultaneous localization and mapping technique. The simultaneous localization and mapping technique is more commonly referred to as SLAM, which refers to the name “Simultaneous Localization and Mapping”.

According to the example described, the SLAM technique implemented by the second processing unit 46 involves two operations.

The first operation is the implementation of a visual inertial odometry technique. The visual inertial odometry technique is more commonly referred to as VIO, which refers to the term “Visual Inertial Odometry”.

The visual inertial odometry technique provides evaluated positions of the sensor 12 within the observation time interval using the reconstructed frames.

The second operation is a mathematical optimization step of all evaluated positions with time.

The optimization operation is sometimes referred to as “bundle adjustment” and consists of minimizing an error that will now be described.

From the positions of the previous images, a new image allows a new position to be obtained by comparing the movements of points of interest identified on each image.

Once the position has been evaluated for each image, it is possible to evaluate the three-dimensional position of each of the points identified on each image.

These points, the three-dimensional position of which is known, can then be reprojected onto each image (in two dimensions). The reprojected points will not be exactly at the location of the observed points, hence the appearance of an error between the measurement and the theoretical projection.

The optimization operation aims to minimize this error.

To do this, the system containing the calculated positions of the camera is transformed, the errors (distances) between the coordinates of the reprojected points and those of the measured/observed points, and the camera model (distortion in particular), into a matrix equation.

The set of evaluated positions allowing to make the matrix equation null is then searched for.

The second data is then the positional data of the object.

These are positional data involving recognition or identification of an object since the position of the object must be defined. Typically, the position of the center of the object will be given but this implies that it is determined what is an object or not. This last determination could, for example, be obtained using a neural network.

It is important to distinguish this position of the center of the object from the position that the first processing chain 14 could provide.

Thus, if the object is a moving animal, the event data will be a set of positions of it and the position determined by the first processing chain 14 will be the barycenter of the set of positions of the event data of this area. However, this determined position is not the position of the animal.

This is because it involves accurately identifying a portion of an image as representing the animal and after that identification, determining its center. There is no reason why the two positions should be identical.

Alternatively, or in addition, the second data comprises object recognition elements.

To repeat the previous example, a second piece of data may be that the animal is a cat or a dog.

The second processing unit 46 is able to transmit the second data at a second transmission frequency f_{émission 2}.

The second transmission frequency f_{émission 2} is relatively low, typically between 1 Hz and 10 Hz. This corresponds to the fact that the second processing unit 46 performs processing that takes time to perform. These processes can therefore be described as heavy or of high computational complexity.

The ratio between the first emission frequency f_{émission 1} and the second emission frequency f_{émission 2} is strictly greater than 1.

Preferably, the ratio between the first emission frequency f_{émission 1} and the second emission frequency f_{émission 2} is strictly greater than 10.

The observation system 10 just described makes it possible to benefit from the advantages of both conventional imagers and event-driven sensors, and in particular from the precision of the processing available for conventional imagers and the high rate of event-driven processing.

In addition, unlike a solution that merges multiple sensor types, the present observation system 10 allows a single calibration to be applied to both event-driven and conventional synchronous data. This provides both an advantage in terms of complexity and an advantage in terms of accuracy because a positional registration between two imaging sensors is never perfect.

In addition, such an observation system 10 allows calculations to be distributed intelligently between the two processing chains 14 and 16 so that one processing chain (the first) operates relatively quickly with simple processing (“where” channel) while the other processing chain (the second) operates relatively slowly with complex processing (“what” channel). As a particular example, in the event data domain, motion blur correction is a linear complexity problem, which is simpler than other motion blur determination techniques.

In addition, the second processing chain 16 benefits from the results of processing already performed by the first processing chain 14, so that the results of the second processing chain 16 are obtained with a gain in speed for a given accuracy.

Finally, compared to other observation systems, relatively few additional calculations are required while allowing only the data useful to the various blocks to be transmitted, which limits the weight, space and energy consumption of the observation system 10.

Because of the above advantages, such an observation system 10 is compatible with an embedded physical implementation.

An example of such an implementation is now described with reference to FIG. 3.

In the illustrated example, the observation system 10 is a stack 80 of three layers 82, 84 and 86 along a stacking direction.

The layers 82, 84 and 86 are stacked on top of each other.

The sensor 12 is fabricated in the first layer 82.

For this purpose, a BSI technique is used, for example.

The acronym BSI stands for “BackSide Illumination” and refers to a sensor manufacturing technique in which the photodiodes of the pixels 20 are positioned in direct contact with the associated collection optics.

In the second layer 84, the first processing chain 14 is realized below the array 18 of pixels 20.

The second layer 84 is connected to the first layer 82 by three-dimensional bonds 88, here of the copper-copper type. Such a type of bond 88 is more often referred to as “3D bonding” in reference to the corresponding English terminology.

The third layer 86 comprises the second processing chain 16.

According to the proposed example, the third layer 86 is also connected to the second layer 84 by three-dimensional bonds 90.

Alternatively, it is possible to consider a wire connection to the second processing chain 16, by positioning the third layer 86 not on top of the other two layers 82 and 84, but on the side, for example on a PCB-type docking device (PCB being the acronym in English for “Printed Circuit Board”).

In each case, the distance between the sensor assembly 12 and the first processing chain 14 must be relatively small and the connection with this assembly made with high-speed and preferably parallel interconnections.

The observation system 10 thus physically implemented presents the advantage of being a small footprint embedded system.

Moreover, the fact that the observation system 10 can directly provide its position and that of the surrounding objects makes it particularly easy to integrate into complex embedded systems, where the management of data streams and the scheduling of the various processing tasks is a source of congestion and is problematic.

According to other embodiments corresponding in particular to applications in which the hardware implementation is less constrained, the physical implementation of the processing chains 14 and 16 is, for example, a computer implementation.

In each case, it may be considered that the observation method implemented by the observation system 10 is a computer-implemented method.

In this way, it has been shown that the observation system 10 can benefit from the advantages of conventional imagers and event-driven sensors while remaining compatible with a physical implementation in an embedded system.

Other embodiments of the observation system 10 benefiting from these advantages are also conceivable.

According to one embodiment, the observation system 10 includes feedback from the second processing chain 16 to at least one of the sensors 12 and the first processing chain 14.

For example, the feedback could be used to adapt the data reception frequency of the first reception unit 30 and/or the conversion frequency of the first conversion block 34.

This adaptation could be performed in real time, that is, during operation of the observation system 10.

According to an alternative, the feedback could be used to provide data from the SLAM technique to improve the implementation of the compensation technique of the compensation subunit 38.

According to another embodiment, the second processing chain 16 also performs preprocessing on the frames from the sensor 12 to facilitate further processing.

In each of the previously presented embodiments, which may be combined with each other to form new embodiments when technically possible, an observation system 10 is proposed for implementing a method of observing an environment, the method comprising a step of acquiring a scene of an environment by a sensor 12 corresponding to a conventional imager, a first step of asynchronous processing of the acquired data to obtain first data, the first processing step comprising a conversion of the acquired data into event data and a second step of synchronous processing on the acquired data and taking into account the first data, the second processing step making it possible to obtain second data.

Such a method allows to benefit from the advantages of conventional imagers and event-driven sensors while remaining compatible with a physical implementation in an embedded system.

Such a device or method is therefore particularly suitable for any application related to embedded vision. Among these applications, on a non-exhaustive basis, can be mentioned surveillance, augmented reality, virtual reality or vision systems for autonomous vehicles or drones, or even embedded motion capture.

1. An observation system for an environment, the observation system comprising:
a sensor including:
an array of pixels, each pixel being a sensor adapted to acquire the intensity of the incident light during an observation of the environment, and
a readout unit, the readout unit being adapted to read the intensity values of the pixels to form a synchronous stream of framed data,
a first processing chain including:
a first reception unit adapted to receive the synchronous stream from the sensor, and
a first processing unit comprising:
a first conversion block for converting the synchronous stream received by the first reception unit into event data, and
a first calculation block adapted to calculate the first data from the event data,
a second processing chain distinct from the first processing chain and including a second processing unit adapted to receive a synchronous stream of framed data from the array of pixels and the first data and of obtaining second data relating to the environment as a function of the synchronous stream and the first data,
the first processing unit including a compensation subunit, the compensation subunit being adapted to receive data relating to the movement of the sensor and adapted to apply a compensation technique to the event data converted by the first conversion block as a function of the received data in order to obtain a compensated event stream,
the first processing unit also comprising a frame reconstruction subunit, the reconstruction subunit being adapted to generate corrected frames from the compensated event stream, the first data including the corrected frames.

2. The observation system according to claim 1, wherein the readout unit presents a first acquisition frequency for the first processing chain and a second acquisition frequency for the second processing chain, the ratio between the first acquisition frequency and the second acquisition frequency being strictly greater than 1.

3. The observation system according to claim 2, wherein the ratio between the first acquisition frequency and the second acquisition frequency is strictly greater than 10.

4. The observation system according to claim 1, wherein the first processing unit is adapted to transmit the first data at a first transmission frequency, the second processing unit is adapted to transmit the second data at a second transmission frequency the ratio between the first transmission frequency and the second transmission frequency being strictly greater than 1.

5. The observation system according to claim 4, wherein the ratio between the first transmission frequency and the second transmission frequency is strictly greater than 10.

6. The observation system according to claim 1, wherein the readout unit presents an adjustable acquisition frequency.

7. The observation system according to claim 1, wherein the readout unit presents analog-to-digital converters presenting an adjustable accuracy.

8. The observation system according to claim 1, wherein the first data are data relating to the temporal evolution of an object in the scene.

9. The observation system according to claim 1, wherein the first processing unit further includes an obtaining subunit, the obtaining subunit being adapted to obtain at least one characteristic relating to the nature of the movement of an object in the scene, the first data including the at least one characteristic obtained.

10. The observation system according to claim 1, wherein the second data are recognition or identification data of an object in the scene.

11. The observation system according to claim 1, wherein the second processing unit is adapted to apply an evaluation technique to the first and second data to obtain evaluated positions of the sensor.

12. The observation system according to claim 11, wherein the evaluation technique is a visual odometry technique or a simultaneous localization and mapping technique.

13. The observation system according to claim 1, wherein the second processing unit (is adapted to perform preprocessing on the synchronous stream.

14. The observation system according to claim 1, wherein the first calculation block performs preprocessing on the synchronous stream to obtain a corrected synchronous stream, the preprocessing, in particular, being adapted to use first data, the second processing unit being adapted to receive the corrected synchronous stream.

15. The observation system according to claim 1, wherein the first processing unit includes a set of cores, each core being associated with a respective set of pixels and applying identical processing on said set of pixels.

16. The observation system according to claim 1, wherein the sensor, the first processing unit and the second processing unit are part of the same component including a stack of at least three layers, the first layer of the stack including the sensor the second layer of the stack including the first processing unit and the third layer including the second processing unit, the second layer being connected to the first layer and to the third layer by respective three-dimensional connections.

17. A method for observing an environment, the observation method being implemented by an observation system, the observation system comprising:
a sensor comprising an array of pixels and a readout unit
a first processing chain including a first reception unit and a first processing unit comprising a first conversion block and a first calculation block,
a second processing chain distinct from the first processing chain and including a second processing unit,
the first processing unit including a compensation subunit, the compensation subunit being adapted to receive data relating to the movement of the sensor and adapted to apply a compensation technique to the event data converted by the first conversion block as a function of the received data in order to obtain a compensated event stream,
the first processing unit also including a frame reconstruction subunit, the reconstruction subunit being adapted to generate corrected frames from the compensated event stream, the first data including the corrected frames,
the observation method comprising the steps of:
acquiring by each pixel the intensity of incident light on the pixel during an observation of the environment,
reading the intensity values of the pixels by the readout unit to form a synchronous stream of framed data,
receiving the synchronous stream from the sensor by the first reception unit,
conversion of the synchronous stream received by the first conversion unit into event data,
calculation of the first data from the event data by the first calculation block,
reception by the second processing unit of the synchronous stream from the sensor and the first data, and
obtaining second data relating to the environment as a function of the data received by the second processing unit.
